(19) United States
(12) Patent Application Publication
(10) Pub. No.: US 2016/0111064 A1
(43) Pub. Date: Apr. 21, 2016

(54) LOAD DRIVING APPARATUS ADAPTED TO DRIVE OUTDOOR DISPLAY

(71) Applicant: Beyond Innovation Technology Co., Ltd., Taipei City (TW)

(72) Inventors: Chen-Lung Kao, Taipei City (TW); Zhen-Chun Liu, Taipei City (TW)

(21) Appl. No.: 14/809,264

(22) Filed: Jul. 26, 2015

(30) Foreign Application Priority Data
Oct. 20, 2014 (TW) 103136139

(51) Int. Cl. G09G 5/10; G09G 3/20; G01J 1/44; G09F 13/00

(52) U.S. Cl. CPC G09G 5/10; G09F 13/00; G09G 3/2014; G01J 1/44; G09G 2320/064; G09G 2360/144; G01J 2001/4473

(57) ABSTRACT

A load driving apparatus adapted to drive an outdoor display is provided. The load driving apparatus includes a weather sensing circuit and a display driver. The weather sensing circuit is configured to sense a weather condition corresponding to an installation place of the outdoor display, and accordingly provides a sensing voltage signal varied along with the weather condition. The display driver is coupled between the weather sensing circuit and the outdoor display, and is configured to drive the outdoor display for displaying in response to the sensing voltage signal. When the weather condition is a cloudy day, the sensing voltage signal is linearly varied within a predetermined voltage range, and then the display brightness of the outdoor display is linearly varied between a maximum brightness and a minimum brightness.

### CROSS-REFERENCE TO RELATED APPLICATION

This application claims the priority benefit of Taiwan application serial no. 103136139, filed on Oct. 20, 2014. The entirety of the above-mentioned patent application is hereby incorporated by reference herein and made a part of this specification.

### BACKGROUND OF THE INVENTION

1. Field of the Invention

The invention relates to a load driving technique, and particularly relates to a load driving apparatus adapted to drive an outdoor display and having a (linear) dimming effect/function.

2. Description of Related Art

In recent years, large-scale outdoor displays/outdoor display billboards are set on outside walls of large buildings for practitioners to convey advertisements or messages. However, the known driving techniques for the large-scale outdoor displays/outdoor display billboards all adopt a fixed driving scheme, such that a display brightness of the large-scale outdoor display/outdoor display billboard is the same regardless of sunny day/daytime or cloudy day/night. Such phenomenon not only brings severe light pollution, but also causes potential hazards to drivers driving at night.

### SUMMARY OF THE INVENTION

The invention is directed to a load driving apparatus adapted to drive an outdoor display and having a (linear) dimming effect/function, so as to effectively resolve the problem referred in the related art.

Other objects and advantages of the invention can be further illustrated by the technical features broadly embodied and described as follows.

An exemplary embodiment of the invention provides a load driving apparatus adapted to drive an outdoor display and having a (linear) dimming effect/function, which includes a weather sensing circuit and a display driver. The weather sensing circuit is configured to sense a weather condition corresponding to an installation place of the outdoor display, and accordingly provides a sensing voltage signal varied along with the weather condition. The display driver is coupled between the weather sensing circuit and the outdoor display, and is configured to drive the outdoor display for displaying in response to the sensing voltage signal. When the weather condition is a cloudy day (or at night), the sensing voltage signal is linearly varied within a predetermined voltage range, such that a display brightness of the outdoor display is linearly varied between a maximum brightness and a minimum brightness.

In an exemplary embodiment of the invention, when the weather condition is a sunny day, the sensing voltage signal is maintained to a predetermined voltage level, such that the display brightness of the outdoor display is maintained to the maximum brightness. Under such condition, the weather sensing circuit includes a photoresistor, an NPN-type bipolar junction transistor, a PNP-type bipolar junction transistor, a first resistor, a second resistor and a first NMOS transistor. A first end of the photoresistor is coupled to a system voltage. A collector of the NPN-type bipolar junction transistor is coupled to the system voltage, and an emitter of the NPN-type bipolar junction transistor is coupled to a second end of the photoresistor. An emitter of the PNP-type bipolar junction transistor is coupled to the system voltage, a collector of the PNP-type bipolar junction transistor is used for generating the sensing voltage signal, and a base of the PNP-type bipolar junction transistor is coupled to the collector of the NPN-type bipolar junction transistor. A first end of the first resistor is coupled to the system voltage, and a second end of the first resistor is coupled to a base of the NPN-type bipolar junction transistor. A first end of the second resistor is coupled to the second end of the first resistor, and a second end of the second resistor is coupled to a ground potential. A drain of the first NMOS transistor is coupled to the emitter of the NPN-type bipolar junction transistor, a gate of the first NMOS transistor is coupled to the system voltage, and a source of the first NMOS transistor is coupled to the ground potential.

In an exemplary embodiment of the invention, when the weather condition is a rainy day or a foggy day, the sensing voltage signal is maintained to the predetermined voltage level, such that the display brightness of the outdoor display is maintained to the maximum brightness. Under such condition, the weather sensing circuit further includes a second NMOS transistor, a first diode, a second diode, a raining sensor and a fogging sensor. A drain of the second NMOS transistor is coupled to the gate of the first NMOS transistor, and a source of the second NMOS transistor is coupled to the ground potential. Cathodes of the first diode and the second diode are coupled to a gate of the second NMOS transistor. The raining sensor is coupled to an anode of the first diode, and is configured to sense whether the weather condition is the rainy day. The fogging sensor is coupled to an anode of the second diode, and is configured to sense whether the weather condition is the foggy day.

In an exemplary embodiment of the invention, the weather sensing circuit further include a delay unit composed of a resistor (R) and a capacitor (C), which is configured to delay and transmit the sensing voltage signal to the display driver.

In an exemplary embodiment of the invention, the weather sensing circuit further includes a reset diode, which is coupled between the delay unit and the system voltage, and is configured to discharge the capacitor (C) in the delay unit to reset the load driving apparatus when the load driving apparatus is shut down.

According to the above descriptions, the load driving apparatus of the invention can detect the weather condition at the installation place of the outdoor display though the photoresistor, the raining sensor and the fogging sensor. When the weather condition is a sunny day (daytime), rainy day or foggy day, the display brightness of the outdoor display is maintained to the maximum brightness. However, when the weather condition is a cloudy day (night), the display brightness of the outdoor display is linearly varied between the maximum brightness and the minimum brightness (for example, as time gradually becomes late, the display brightness of the outdoor display is linearly varied from the maximum brightness to the minimum brightness). In this way, not only the light pollution is mitigated/suppressed, but also the potential hazards to drivers driving at night is decreased.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system structural diagram of a load driving apparatus according to an exemplary embodiment of the invention.

FIG. 2 is a block diagram of the load driving apparatus of FIG. 1.

FIG. 3 is a circuit diagram of the load driving apparatus of FIG. 2.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

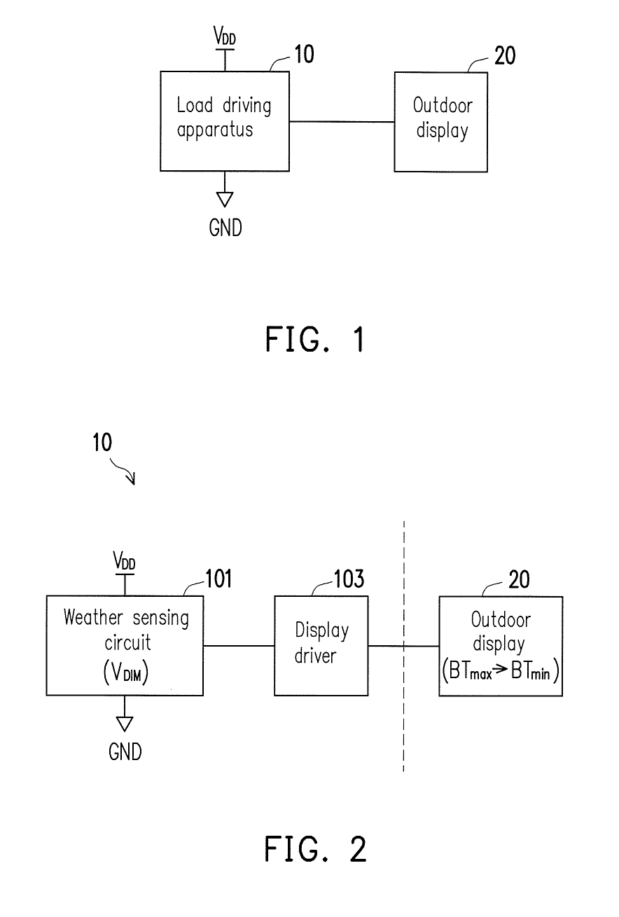

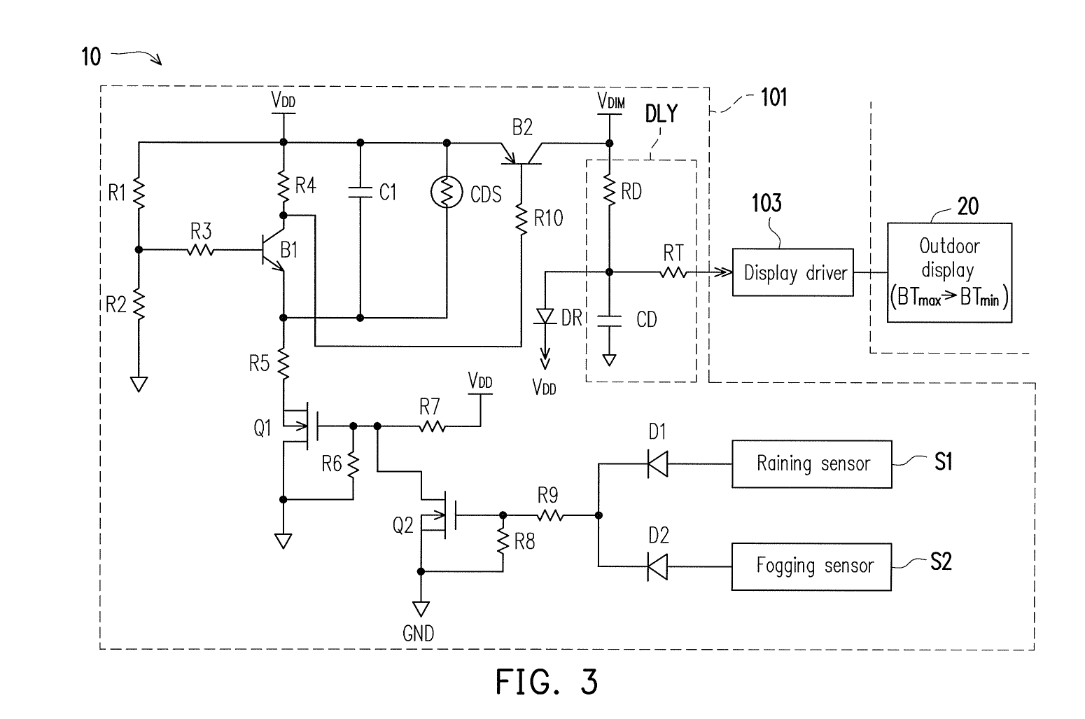

FIG. 1 is a system structural diagram of a load driving apparatus 10 according to an exemplary embodiment of the invention. FIG. 2 is a block diagram of the load driving apparatus 10 of FIG. 1. FIG. 3 is a circuit diagram of the load driving apparatus 10 of FIG. 2. Referring to FIG. 1-FIG. 3, the load driving apparatus 10 is adapted to drive an outdoor display 2 or an outdoor display billboard of any type, though the invention is not limited thereto. Moreover, the load driving apparatus 10 may include a weather sensing circuit 101 and a display driver 103.

In the present exemplary embodiment, the weather sensing circuit 101 is configured to sense a weather condition (for example, a sunny data (daytime), a cloudy day (night), a rainy day, a foggy day, etc.) corresponding to an installation place of the outdoor display 20, and accordingly provides a sensing voltage signal V_{DIM} varied along with the weather condition. Moreover, the display driver 103 is coupled between the weather sensing circuit 101 and the outdoor display 20, and is configured to drive the outdoor display 20 for (image) displaying in response to the sensing voltage signal V_{DIM} provided by the weather sensing circuit 101 by (for example) adopting a pulse width modulation (PWM) scheme (though the invention is not limited thereto).

It should be noticed that when the weather condition is a cloudy day (or at night), the sensing voltage signal V_{DIM} provided by the weather sensing circuit 101 is linearly varied within a predetermined voltage range (for example, a voltage range between a system voltage V_{DD} and a ground potential GND, though the invention is not limited thereto), such that a display brightness of the outdoor display 20 is linearly varied between a maximum brightness BTmax and a minimum brightness BTmin. Moreover, when the weather condition is a sunny day, a rainy data or a foggy day, the sensing voltage signal V_{DIM} provided by the weather sensing circuit 101 is maintained to a predetermined voltage level (for example, the ground potential GND, though the invention is not limited thereto), such that the display brightness of the outdoor display 20 is maintained to the maximum brightness BTmax.

In detail, as shown in FIG. 3, the weather sensing circuit 101 may include a photoresistor CDS, an NPN-type bipolar junction transistor (BJT) B1, a PNP-type BJT B2, resistors R1-R10, NMOS transistors (Q1,Q2), a capacitor C1, diodes (D1, D2), a reset diode DR, a delay unit DLY, a raining sensor S1 and a fogging sensor S2.

In the present exemplary embodiment, a first end of the photoresistor CDS is coupled to the system voltage V_{DD}, and the capacitor C1 is connected in parallel to the photoresistor CDS. A collector of the NPN-type BJT B1 is coupled to the system voltage V_{DD} through the resistor R4, and an emitter of the NPN-type BJT B1 is coupled to a second end of the photoresistor CDS. An emitter of the PNP-type BJT B2 is coupled to the system voltage V_{DD}, a collector of the PNP-type BJT B2 is used for generating the sensing voltage signal V_{D1M} varied along with the weather condition, and a base of the PNP-type BJT B2 is coupled to the collector of the NPN-type BJT B1 through the resistor R10.

A first end of the resistor R1 is coupled to the system voltage V_{DD}, and a second end of the resistor R1 is coupled to a base B1 of the NPN-type BJT B1 through the resistor R3. A first end of the second resistor R2 is coupled to the second end of the first resistor R1, and a second end of the second resistor R2 is coupled to the ground potential GND. A drain of the NMOS transistor Q1 is coupled to the emitter of the NPN-type BJT B1 through the resistor R5, a gate of the NMOS transistor Q1 is respectively coupled to the ground potential GND and the system voltage V_{DD} through the resistors R6 and R7, and a source of the NMOS transistor Q1 is coupled to the ground potential GND.

A drain of the NMOS transistor Q2 is coupled to the gate of the NMOS transistor Q1, and a source of the NMOS transistor Q2 is coupled to the ground potential GND. Cathodes of the diodes D1 and D2 are coupled to a gate of the NMOS transistor Q2 through the resistor R9, and the resistor R8 is coupled between the gate of the NMOS transistor Q2 and the ground potential GND. The raining sensor S1 is coupled to an anode of the diode D1, and is configured to sense whether the weather condition is the rainy day (note: if yes, the raining sensor S1 outputs a high level (Hi) sensing signal, and conversely outputs a low level (Lo) sensing signal). The fogging sensor S2 is coupled to an anode of the diode D2, and is configured to sense whether the weather condition is the foggy day (note: if yes, the fogging sensor S2 outputs a high level (Hi) sensing signal, and conversely outputs a low level (Lo) sensing signal).

It should be noticed that in a selective exemplary embodiment, a part of the passive components (R, C) can be omitted (i.e., optional) as long as a normal operation or an actual design/application requirement of the weather sensing circuit 101 is not influenced.

Moreover, the delay unit DLY is configured to delay and transmit the sensing voltage signal V_{DIM} to the display driver 103. Moreover, the delay unit DLY can be composed of a delay resistor RD, a delay capacitor CD and a transmission resistor RT, though the invention is not limited thereto. A first end of the delay resistor RD is coupled to the collector of the PNP-type BJT B2. A first end of the transmission resistor RT is coupled to a second end of the delay resistor RD, and a second end of the transmission resistor RT transmits the delayed sensing voltage signal V_{DIM} to the display driver 103. A first end of the delay capacitor CD is coupled to the second end of the delay resistor RD, and a second end of the delay capacitor CD is coupled to the ground potential GND. In the present exemplary embodiment, the delay unit DLY can be used to avoid a wrong operation of the load driving apparatus 10 in case of an excessively large transient change of environment light (e.g., flash of lighting). Similarly, in a selective exemplary embodiment, the delay unit DLY can be omitted (i.e., optional) as long as a normal operation or an actual design/application requirement of the weather sensing circuit 101 is not influenced.

The reset diode DR is coupled between the delay unit DLY and the system voltage V_{DD}, for example, an anode of the reset diode DR is coupled to the first end of the delay capacitor CD, and a cathode of the reset diode DR is coupled to the system voltage V_{DD}. Moreover, the reset diode DR is configured to discharge the capacitor CD to reset the load driving apparatus 10 when the load driving apparatus 10 is shut down. In this way, unnecessary brightness change of the display brightness of the outdoor display 20 occurred when the load driving apparatus 10 is rebooted is avoid. Similarly, in a selective exemplary embodiment, the reset diode DR can be omitted (i.e., optional) as long as a normal operation or an actual design/application requirement of the weather sensing circuit 101 is not influenced.

According to the above description, it is assumed that the weather condition of the installation place of the outdoor display 20 is a sunny day (or daytime), and the photoresistor CDS has a low impedance (which is approximately equal to 1 KΩ). Under such condition, since an emitter voltage VE of the NPN-type BJT B1 is higher than a base voltage VB thereof, the NPN-type BJT B1 and the PNP-type BJT B2 are simultaneously turned off, such that the sensing voltage signal V_{DIM} is in a floating state to present a high impedance (which is approximately equal to the ground potential GND). Therefore, the display driver 103 drives the outdoor display 20 for (image) displaying in response to the sensing voltage signal V_{DIM} maintained to 0V, and maintains the display brightness of the outdoor display 20 to the maximum brightness BTmax, such that an advertisement or message displayed on the outdoor display 20 by a practitioner can be clearly viewed under the weather condition of sunny day (or daytime).

On the other hand, it is assumed that the weather condition of the installation place of the outdoor display 20 is a rainy day or foggy day, and one of the raining sensor S1 and the fogging sensor S2 outputs a high level sensing signal to turn on the NMOS transistor Q2 and turn off the NMOS transistor Q1. Under such condition, since the NPN-type BJT B1 and the PNP-type BJT B2 are simultaneously turned off, the sensing voltage signal V_{DIM} is in the floating state to present the high impedance (which is approximately equal to the ground potential GND). Therefore, the display driver 103 drives the outdoor display 20 for (image) displaying in response to the sensing voltage signal V_{DIM} maintained to 0V, and maintains the display brightness of the outdoor display 20 to the maximum brightness BTmax, such that the advertisement or message displayed on the outdoor display 20 by a practitioner can be clearly viewed under the weather condition of rainy day or fogging day.

Moreover, it is assumed that the weather condition of the installation place of the outdoor display 20 is a cloudy day (or night), the photoresistor CDS gradually presents a high impedance as the environment light is gradually dimmed. Under such condition, since the base voltage VB of the NPN-type BJT B1 is higher than the emitter voltage VE thereof, the NPN-type BJT B1 and the PNP-type BJT B2 are simultaneously turned on, such that the sensing voltage signal V_{DIM} presents a linear variation within a predetermined voltage range (i.e., 0V-V_{DD}). Therefore, the display driver 103 drives the outdoor display 20 for (image) displaying in response to the sensing voltage signal V_{DIM} presenting the linear variation, and makes the display brightness of the outdoor display 20 to present a linear variation between the maximum brightness BTmax and the minimum brightness BTmin (for example, as time becomes late, the display brightness of the outdoor display 20 is changed from the maximum brightness BTmax to the minimum brightness BTmin), so as to implement a linear dimming effect/function of the outdoor display 20. In this way, not, only the light pollution caused by the outdoor display 20 is mitigated/suppressed, but also the potential hazards to drivers driving at night is decreased.

In summary, the load driving apparatus 10 of the invention can detect the weather condition at the installation place of the outdoor display 20 though the photoresistor CDS, the raining sensor S1 and the fogging sensor S2. When the weather condition is a sunny day (daytime), rainy day or foggy day, the display brightness of the outdoor display 20 is maintained to the maximum brightness (BTmax), such that the advertisement or message displayed on the outdoor display 20 by a practitioner can be clearly viewed under the weather condition of sunny day, rainy day or fogging day. However, when the weather condition is a cloudy day (night), the display brightness of the outdoor display 20 is linearly varied between the maximum brightness (BTmax) and the minimum brightness (BTmin) (for example, as time gradually becomes late, the display brightness of the outdoor display 20 is linearly varied from the maximum brightness (BTmax) to the minimum brightness (BTmin)), so as to implement a linear dimming effect/function of the outdoor display 20. In this way, not only the light pollution caused by the outdoor display 20 is mitigated/suppressed, but also the potential hazards to drivers driving at night is decreased.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A load driving apparatus, adapted to drive an outdoor display, the load driving apparatus comprising:
a weather sensing circuit, configured to sense a weather condition corresponding to an installation place of the outdoor display, and accordingly providing a sensing voltage signal varied along with the weather condition; and
a display driver, coupled between the weather sensing circuit and the outdoor display, and configured to drive the outdoor display for displaying in response to the sensing voltage signal,
wherein when the weather condition is a cloudy day, the sensing voltage signal is linearly varied within a predetermined voltage range, such that a display brightness of the outdoor display is linearly varied between a maximum brightness and a minimum brightness.

2. The load driving apparatus as claimed in claim 1, wherein when the weather condition is a sunny day, the sensing voltage signal is maintained to a predetermined voltage level, such that the display brightness of the outdoor display is maintained to the maximum brightness.

3. The load driving apparatus as claimed in claim 2, wherein the weather sensing circuit comprises:
a photoresistor, having a first end coupled to a system voltage;
an NPN-type bipolar junction transistor, having a collector coupled to the system voltage, and an emitter coupled to a second end of the photoresistor;
a PNP-type bipolar junction transistor, having an emitter coupled to the system voltage, a collector configured to generate the sensing voltage signal, and a base coupled to the collector of the NPN-type bipolar junction transistor;
a first resistor, having a first end coupled to the system voltage, and a second end coupled to a base of the NPN-type bipolar junction transistor;
a second resistor, having a first end coupled to the second end of the first resistor, and a second end coupled to a ground potential; and
a first NMOS transistor, having a drain coupled to the emitter of the NPN-type bipolar junction transistor, a gate coupled to the system voltage, and a source coupled to the ground potential.

4. The load driving apparatus as claimed in claim 3, wherein the weather sensing circuit further comprises:
a delay unit, configured to delay and transmit the sensing voltage signal to the display driver.

5. The load driving apparatus as claimed in claim 3, wherein the delay unit comprises:
a delay resistor, having a first end coupled to the collector of the PNP-type bipolar junction transistor;
a transmission resistor, having a first end coupled to a second end of the delay resistor, and a second end transmitting the delayed sensing voltage signal to the display driver; and
a delay capacitor, having a first end coupled to the second end of the delay resistor, and a second end coupled to the ground potential.

6. The load driving apparatus as claimed in claim 5, wherein the weather sensing circuit further comprises:
a reset diode, coupled between the delay unit and the system voltage, and configured to discharge the delay capacitor to reset the load driving apparatus when the load driving apparatus is shut down,
wherein an anode of the reset diode is coupled to the first end of the delay capacitor, and a cathode of the reset diode is coupled to the system voltage.

7. The load driving apparatus as claimed in claim 3, wherein when the weather condition is a rainy day or a foggy day, the sensing voltage signal is maintained to the predetermined voltage level, such that the display brightness of the outdoor display is maintained to the maximum brightness.

8. The load driving apparatus as claimed in claim 7, wherein the weather sensing circuit further comprises:
a second NMOS transistor, having a drain coupled to the gate of the first NMOS transistor, and a source coupled to the ground potential;
a first diode, having a cathode coupled to a gate of the second NMOS transistor;
a second diode, having a cathode coupled to the gate of the second NMOS transistor;
a raining sensor, coupled to an anode of the first diode, and configured to sense whether the weather condition is the rainy day; and
a fogging sensor, coupled to an anode of the second diode, and configured to sense whether the weather condition is the foggy day.

9. The load driving apparatus as claimed in claim 8, wherein the predetermined voltage range is determined by the system voltage and the ground potential, and the predetermined voltage level is the ground potential.

10. The load driving apparatus as claimed in claim 8, wherein the weather sensing circuit further comprises:
a first capacitor, connected with the photoresistor in parallel;
a third resistor, having a first end coupled to the second end of the first resistor and the first end of the second resistor, and a second end coupled to the base of the NPN-type bipolar junction transistor;
a fourth resistor, coupled between the system voltage and the collector of the NPN-type bipolar junction transistor;
a fifth resistor, coupled between the emitter of the NPN-type bipolar junction transistor and the drain of the first NMOS transistor;
a sixth resistor, coupled between the gate of the first NMOS transistor and the ground potential;
a seventh resistor, coupled between the gate of the first NMOS transistor and the system voltage;
an eighth resistor, coupled between coupled between the gate of the second NMOS transistor and the ground potential;
a ninth resistor, coupled between the gate of the second NMOS transistor and cathodes of the first and second diodes; and
a tenth resistor, coupled between the base of the PNP-type bipolar junction transistor and the collector of the NPN-type bipolar junction transistor.

11. The load driving apparatus as claimed in claim 1, wherein the display driver adopts a pulse width modulation scheme to drive the outdoor display for displaying.
